(19) United States
(12) Patent Application Publication
(10) Pub. No.: US 2008/0065342 A1
(43) Pub. Date: Mar. 13, 2008

(54) APPARATUS AND METHOD TO PROVIDE POWER GRID DIAGNOSTICS

(75) Inventors: Yeshayahu Zalitzky, Raanana (IL); Elay Goldstein, Bat-Yam (IL)

Correspondence Address: MAINNET COMMUNICATIONS, 47 HANESSIIM ST., RA'ANANA, 43583, omitted

(73) Assignee: MainNet Communications Ltd.

(21) Appl. No.: 11/852,438

(22) Filed: Sep. 10, 2007

Related U.S. Application Data
(60) Provisional application No. 60/825,153, filed on Sep. 11, 2006.

(51) Int. Cl. G01M 19/00

(52) U.S. Cl. 702/108; 702/66

(57) ABSTRACT

A system, apparatus and method that may enable recognition, identification and/or diagnosis of malfunctioning elements in a power grid. The system includes a processor running a diagnostics algorithm to determine grid element problems from measured transmission signals.

### CROSS REFERENCE TO RELATED APPLICATIONS

This application claims priority from U.S. Provisional Patent Application No. 60/825,153, filed 11 Sep. 2006, entitled “APPARATUS AND METHOD TO PROVIDE POWER GRID DIAGNOSTICS”, which is incorporated in its entirety herein by reference.

### BACKGROUND

The present invention relates to a system and method for providing power grid diagnostics

Various systems have been described that aim to provide diagnostic intelligence to power grids. One example is described in U.S. Pat. No. 7,076,378, by Huebner, which described an apparatus that may determine a characteristic of a portion of a power line. A further example is described in application number 20020161542, by Jones, Keith R. et al., that describes a method and system for performing sequence time domain reflectometry to determine the location of line anomalies in a communication channel.

There is thus a widely recognized need for, and it would be highly advantageous to have, a system and method that can enable accurate diagnostics on power lines, for example, to identify malfunctioning elements in the power grid.

### SUMMARY OF THE INVENTION

There is provided, in accordance with an embodiment of the present invention, an apparatus, system, and method for enabling recognition, identification and/or diagnosis of malfunctioning elements in a power grid. The system includes a processor running a diagnostics algorithm to determine grid element problems from measured transmission signals. According to some embodiments a coupling device adapted to measure transmissions at a point in an electric grid is coupled to a processing device, to process data received by said coupling device. The processor may run a diagnostic algorithm running that may operate in the radio frequency (RF) to detect malfunctioning power grid elements, in accordance with the measured transmission signals.

### BRIEF DESCRIPTION OF THE DRAWINGS

The principles and operation of a system and a method according to the present invention may be better understood with reference to the drawings, and the following description, it being understood that these drawings are given for illustrative purposes only and are not meant to be limiting, wherein:

FIG. 1 is a schematic chart showing operational steps according to some embodiments;

FIG. 2 is a schematic illustration of a diagnostics system, according to some embodiments;

FIG. 3 is a flow chart illustrating operational steps according to some embodiments; and

FIG. 4 is a schematic illustration of a diagnostics system, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

Embodiments of the present invention relate to power grid diagnostics, and in particular, identifying malfunctioning elements in the power grid. For example, malfunctioning transformers, lines, capacitors, and isolators, etc., may be diagnosed. In some embodiments failure of malfunctioning elements may be prevented using these diagnostics.

In some embodiments diagnostic algorithms are provided that operate in the radio frequency (RF), to detect malfunctioning power grid elements, for example, that may be non-operational or malfunctioning. For example, when abnormal RF energy is detected, this information may be processed and a request may be sent to check the element in order to perform the necessary prevention maintenance, for example, before an actual failure will occur. In this way the electricity circuit may work more effectively and be more stable, for example, by reducing the electricity outage time. In some embodiments, the specific frequencies of disturbances and/or the regularity of those disturbances may be measured, such that each specific measurement may provide an indication as to a particular problem or disturbance in an electric grid.

According to some embodiments, a diagnostic apparatus is provided that may include a coupling device (e.g., such as described in U.S. Pat. No. 6,927,672, which is hereby included herein by reference), an amplifier, A/D and CPU. Other elements or combinations of elements may be used.

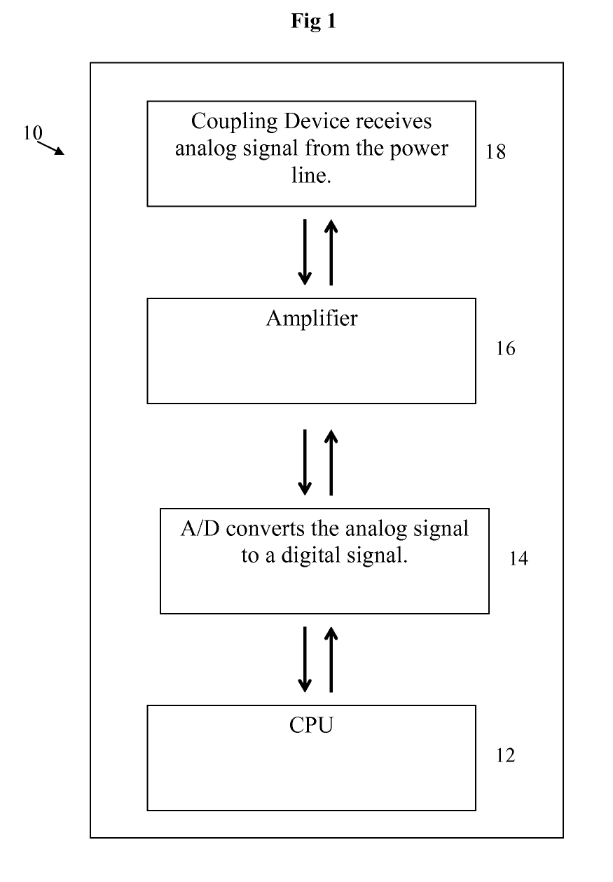

Reference is now made to FIG. 1, which depicts an apparatus 10 for receiving and transmitting analog signals to and from the power line, according to some embodiments. A signal may be transmitted to the power line via a CPU 12, that sends a digital signal to a digital to analog (D/A) converter 14. The D/A 14 may transfer an analog signal to an amplifier 16, which may transfer the amplified signal to a coupling device 18. The coupling device 18 may communicate the signal to the power line. In some embodiments, two or more apparatuses 10 may be used in a network, such that signals transmitted between the apparatus may be measured by other apparatuses, thereby enabling a variety of elements along the grid to be measured. In this way, for example, an electric grid may be equipped with a plurality of apparatuses to enable particular grid elements to be diagnosed and noises or other problems to be noticed and identified. In some embodiments apparatus 10 may enable signals transmitted along an electric line to be intercepted, measured and identified, with or without the usage of a second apparatus 10.

In other embodiments, a signal may be received from a power line via coupling device 18. The coupling device 18 may transfer the analog signal to A/D converter 14, which may transfer the signal to the amplifier 16. The amplifier 14 may transfer the signal to the A/D converter 14 may transfer a digital signal to the CPU 12. The CPU may process the digital signal and perform diagnostic tests of the power line.

In some embodiments the CPU may measure one or more of the bit error rate, packet lost probability, signal to noise ratio, a noise characterization, interference characterization, frequency response, phase response, and amplitude response etc. The CPU may determine channel quality by calculating the up to date percentage of received packets versus transmitted packets between two units.

In one embodiment a method for determining diagnostics in a power line communications system may include checking the noise characterization in the RF band (e.g., time distribution, power distribution, frequency band etc.). In one example, abnormal behavior values in the above measurements may indicate a failure location.

There may be various characteristics for specific failures occurring on the grid that may be indicated by theory analysis of the noise over the grid. In some embodiments the apparatus may perform measurements on the RF band and analyze the noise characterization result from spikes, saturation, poor contacts etc., which may indicate interruptions or malfunctions of power grid elements. For example, a saturated transformer may contribute noise that correlates to 50 HZ; electrical engine emission noises may correlate to the zero voltage crossing; loads, such as dimmers, switching power supplies, and other communication media, may contribute noises in the range of 100 Hz and 1 MHz. Noise bursts gaps correlated to 100 Hz/120 Hz may indicate a poor contact in the wiring of the power grid. In the noise analysis, street light noises may be ignored.

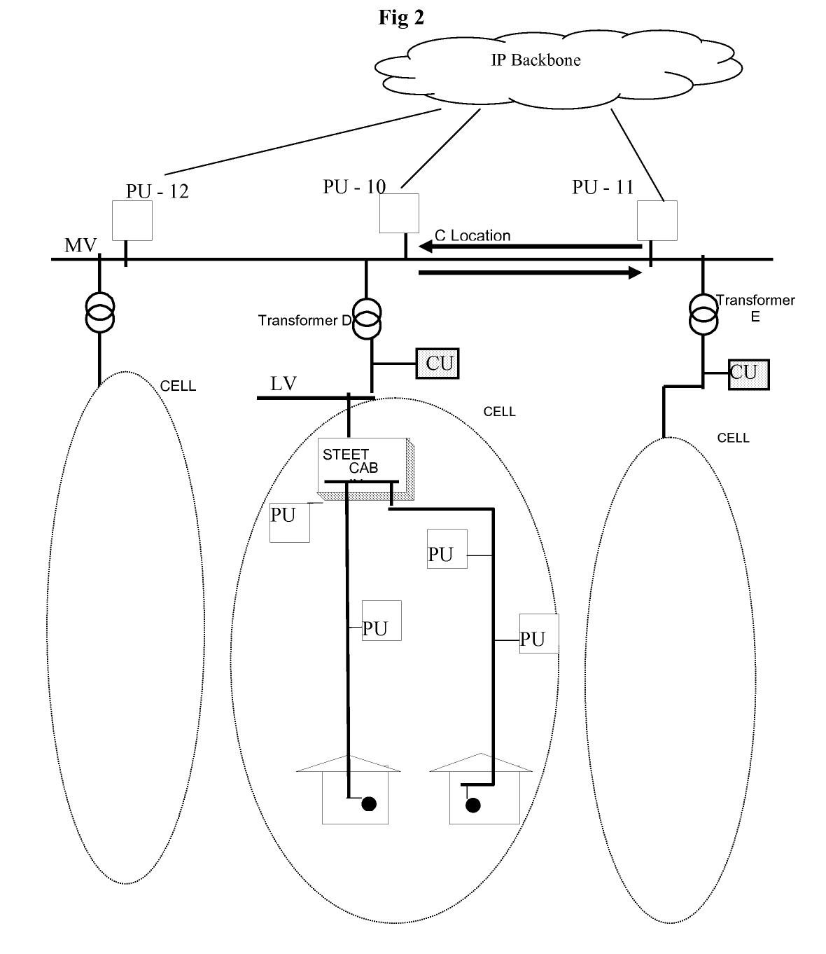

Reference is now made to FIG. 2, which shows a schematic illustration of a power line network topology which includes control units (CUs), which, interface between an external data network and a power line (e.g., medium voltage (MV) and/or low voltage (LV)), and Power Line Communication Units (PUs) that help to overcome the noises and/or attenuation on a power line. There may be various characteristics for specific failures occurring on the grid that are able to be indicated by theory analysis of the noise over the grid. FIG. 2 shows an illustrative transformer in saturation (transformer D), consequently there might be at edge location (C), proximate to transformer D, a noise distribution that correlates to approximately 50 Hz. Such an event may indicate or detect a malfunctioning transformer. Such malfunctions may be determined for elements coupled to MV and/or LV lines.

In a further embodiment a diagnostics apparatus may include two or more units, a first unit to send a test signal to the power line, and a second unit to receive the signal. Following this test signal, a diagnostics method may be implemented that includes, for example, checking packet loss distribution, and correlation of packet loss distribution to range of approximately 50-60 Hz. Other ranges may be used. The method may include detecting incompatibility between signal to noise ratio (SNR) and packet lost probability, and/or asymmetric incompatibility of two link directions between two units, in order to detect malfunctioning elements. The apparatus may be examined on two or more units.

In some embodiments, diagnostics may be determined by detecting links on the power line with reasonable SNR and abnormal packet loss probability and/or packet loss distribution behavior.

In some embodiments, measurements may indicate if there is a malfunctioning element, for example, that causes a noise burst at a relevant frequency and/or of a relevant length. According to some embodiments there is a direct relationship between the noise level and the number of lost packets during transmission. For example, if Transformer D causes a noise burst every 10 msec and has a burst length of 2 msec, the percentage of received packets versus transmitted packets measured by a unit proximate to that element, PU 10, from all other neighboring units (PU-11, PU-12 etc.), may be low or equal to approximately 80% efficiency, or 20% noise. Such a consideration may be used to indicate the existence of problem, and location. This may be calculated, for example, according to the following formula. Other thresholds, limits, measurements etc. may be used.

$$100 \% - \frac{Noise burst gap}{Burst length} = \begin{matrix}Percentage of recieved packets \\ versus transmitted packets for \\ each neighboring unit .\end{matrix}$$

In some embodiment a method for detecting locations with incompatibility between signal to noise ratio (SNR) and packet lost probability may be implemented. Additionally, a method may be implemented for detecting asymmetric incompatibility of two link directions between all units.

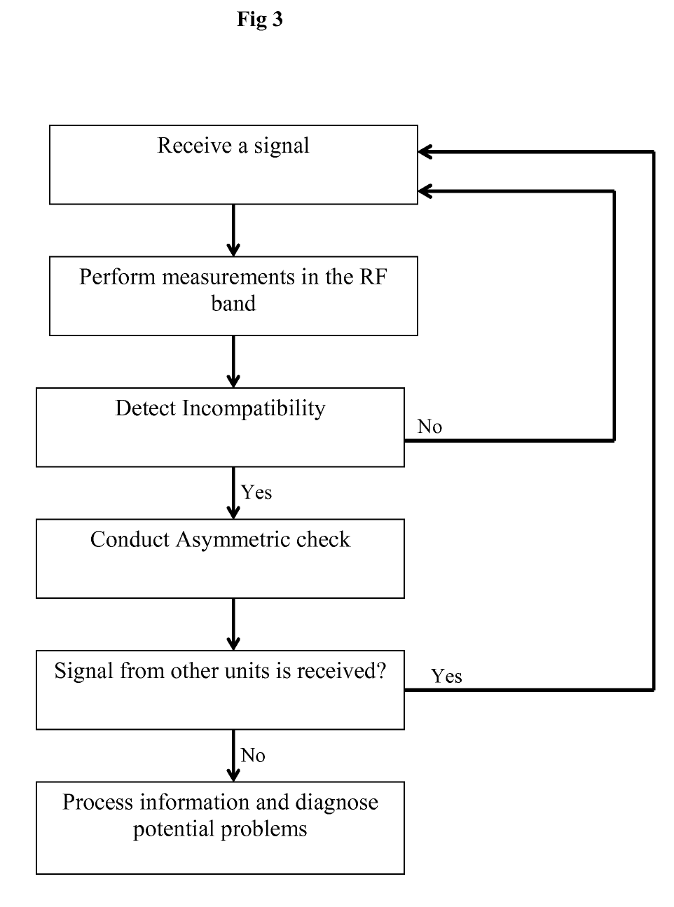

As can be seen with reference to FIG. 3, the CPU may receive a signal and perform measurements in the RF band, for example, by checking the reception quality. For example, the SNR and/or packet lost probability may be measured. The CPU may compare the determined values in order to detect incompatibility. If there is no incompatibility, nothing should be done, and the CPU waits to receive another transmission. If there is incompatibility, the unit may communicate with a second unit on the other side of the link and compare the determined SNR and packet lost probability values in order to detect an asymmetric link. In some embodiments the CPU may further check if there is another transmission from one or more other units. If there are one or more other transmissions, the CPU may conduct the measurement again in relation to the new unit(s), in order to confirm or strengthen the indication of malfunctioning at the selected location. After the signals transmitted between all relevant neighboring units have been checked, the CPU may process the relevant information and determine or diagnose one or more problems, malfunctions, failings etc. For example, the CPU, after diagnosing a malfunction, may send a request to check the element before it actually fails.

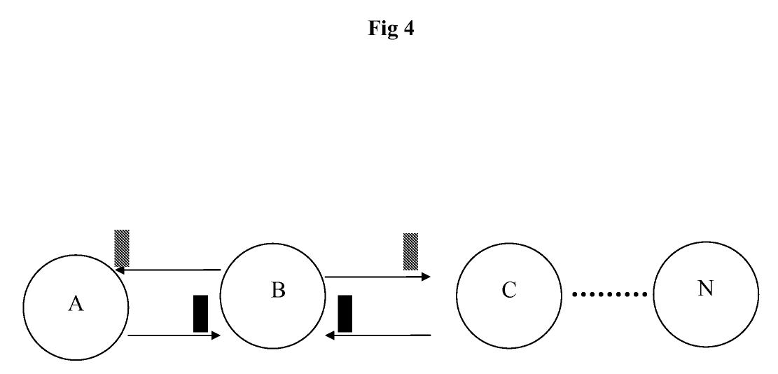

In further embodiments, as can be seen with reference to FIG. 4, an asymmetric link with a good SNR and low packet lost probability in one link direction (A), and a good SNR and high packet lost probability on the other link direction (B), on the same link, are illustrated. The CPU in each unit may check the reception and/or transmission quality, for example by measuring SNR and packet lost probability, and comparing with one or more other units. As shown in FIG. 4, unit A and unit B may communicate a signal to each other. When B's transmission to A yields a reasonable signal to noise ratio (SNR) and low packet lost probability, and B's transmission to A yields a reasonable SNR but high packet lost probability, this may indicate a probability that there may be element interruptions proximate to unit B. If there is another unit (C) that communicates a signal to unit B and the determined packet lost probability in B as it relates to C is also high, it may confirm or increase the probability that an element in proximity to unit B may have failed or may be malfunctions.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for identifying malfunctioning elements in a power grid, comprising:
a coupling device adapted to measure transmissions at a point in an electric grid;
a processing device coupled to said coupler, to process data received by said coupling device; and
a diagnostic algorithm running on said processing device, said algorithm configured to operate in the radio frequency (RF) to detect malfunctioning power grid elements.

2. The system of claim 1, wherein said processing device is adapted to measure one or more elements selected from the group consisting of bit error rate, packet lost probability, signal to noise ratio, a noise characterization, interference characterization, frequency response, phase response, and amplitude response.

3. The system of claim 1, wherein said processing device is adapted to diagnose electric grid problems according to the frequencies of said transmissions.

4. A method for identifying malfunctioning elements in a power grid, comprising:
detecting an RF signal received by a transceiver coupled to the power grid;
processing RF energy data in the radio frequency; and
determining whether said RG energy is abnormal.

5. The method of claim 4, comprising conducting an asymmetry check on said RF energy data.

6. The method of claim 4, comprising diagnosing potential problems associated with elements on the grid.

7. The method of claim 6, wherein said potential problems are diagnosed according to the frequency of a detected signal.

8. The method of claim 4, comprising sending an alert to perform maintenance on a grid element related to the causation of said abnormality.

9. The method of claim 4, comprising checking the noise characterization in the RF band.

10. The method of claim 4, comprising sending a test signal from said processing device, to said electric grid.

11. An apparatus for identifying malfunctioning elements in a power grid, comprising:
a coupling device adapted to measure transmissions at a point in an electric grid;
a processing device coupled to said coupler, to process signals received by said coupling device, said processing device being adapted to detect malfunctioning power grid elements.

12. The apparatus of claim 11, including an algorithm running in the FR, adapted to determine power grid element problems according to the frequencies of said transmissions.
